(19) United States
(12) Patent Application Publication
(10) Pub. No.: US 2011/0099907 A1
(43) Pub. Date: May 5, 2011

(54) DOOR VIEWER BLOCKER

(76) Inventors: CURTIS LEE ANDERSON, (US); ROBERT EUGENE GATEHOUSE, (US)

(21) Appl. No.: 12/939,123

(22) Filed: Nov. 3, 2010

Related U.S. Application Data
(60) Provisional application No. 61/257,815, filed on Nov. 3, 2009.

(51) Int. Cl. E06B 7/30

(52) U.S. Cl. 49/171

(57) ABSTRACT

An exemplary embodiment provides for a device for selectively blocking a view through a door viewer includes a ring mountable over a door viewer wherein the ring encircles the door viewer and a cover rotatably coupled to the ring.

### PRIORITY STATEMENT

The present application hereby claims the benefit of priority of U.S. Provisional Patent Application Ser. No. 61/257,815, filed on Nov. 3, 2009, entitled “ViewBlocker,” and is herein incorporated by reference.

### BACKGROUND

Door viewers, also referred to as peepholes, are commonplace in hotel room and apartment entry doors. They conveniently allow a person to ascertain who is at the exterior of the entry door without actually unlocking and opening the entry door. The optics of door viewers are designed such that a person at the exterior of the entry door can not see into the apartment or hotel room. However, there have been instances where door viewers have been modified and an interior can be visible is some manner. Due to this deficiency of door viewers, room for improvement exists.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The claimed embodiments provide for a device for selectively blocking a view through a door viewer includes a ring mountable over a door viewer wherein the ring encircles the door viewer and a cover rotatably coupled to the ring.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is an isometric view of an opened viewer blocker, in accordance with an exemplary embodiment;

FIG. 2 is an isometric view of a closed viewer blocker, in accordance with an exemplary embodiment;

FIG. 3 is a side elevational view of a viewer blocker, in accordance with an exemplary embodiment;

FIG. 4 is a top plan view of an opened viewer blocker, in accordance with an exemplary embodiment;

FIG. 5 is a top plan view of a closed viewer blocker, in accordance with an exemplary embodiment;

FIG. 6 is a cross-sectional view of the closed viewer blocker of FIG. 5 taken along line A-A, in accordance with an exemplary embodiment;

FIG. 7 is an isometric view of an outer cover, in accordance with an exemplary embodiment;

FIG. 8 is an isometric view of an inner ring, in accordance with an exemplary embodiment; and

FIG. 9 is an isometric view of a pin, in accordance with an exemplary embodiment.

### DETAILED DESCRIPTION

The claimed embodiments provide for a door viewer blocker. The door viewer blocker includes an inner ring and an outer cover rotatably coupled at an edge of the inner ring. The inner ring is attached, to a door, over/around a door viewer. When it is desired for the door viewer to be blocked, the outer cover is positioned to be flush with the inner ring. When it is desired for the door viewer to not be blocked, the outer cover is positioned not to be flush with the inner ring.

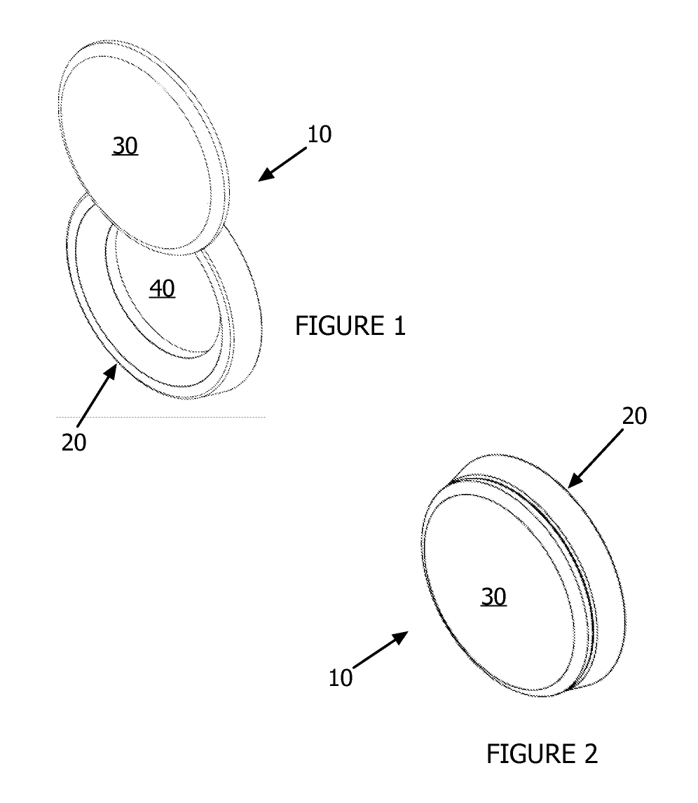

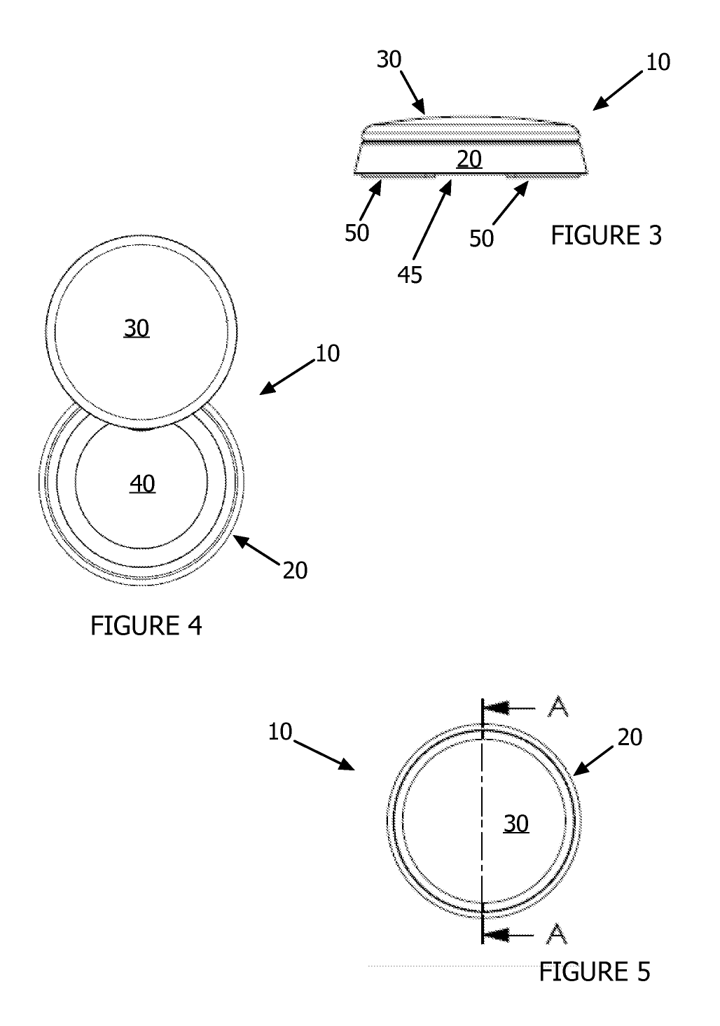

Various views of a door viewer blocker 10 are shown in FIGS. 1-6. Door viewer blocker 10 includes an inner ring 20 and an outer cover 30. Outer cover 30 is rotatably coupled to an edge of the inner ring 20 such that the outer cover 30 may cover an inner area 40 of the inner ring 20. FIGS. 1 and 4 show the outer cover 30 not covering the inner area 40 and FIGS. 2-3 and 5-6 show the outer cover 30 covering the inner area 40 of the inner ring 10. In other implementations, the outer cover 30 may be detachably-coupled to the inner ring via a snap-fit, magnets, etc.

The door viewer blocker 10 is typically placed over a door viewer such that the inner ring 20 surrounds a door viewer. The door viewer blocker 10 may be placed on a door via a variety of methods. For example, a backside 45 of the inner ring 20 may have die cut adhesive 50 attached which has a peel off backing. The backing may be removed and the door viewer blocker is placed over a door viewer. An example of die cut adhesive that may be utilized is VHB (Very High Bond) tape by 3M Corporation. Die cut adhesive may considered to be a more permanent method of attaching a door view blocker 10 to a door. Another example of a permanent method of attaching a door viewer blocker 10 to a door is to utilize screws. In another implementation, a door viewer blocker 10 may be attached to a door via a detachable-mounting means such as velcro.

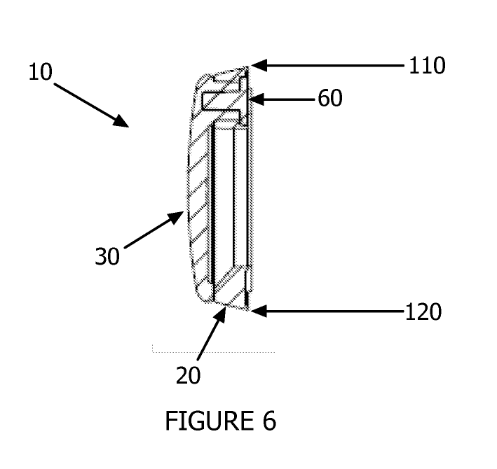

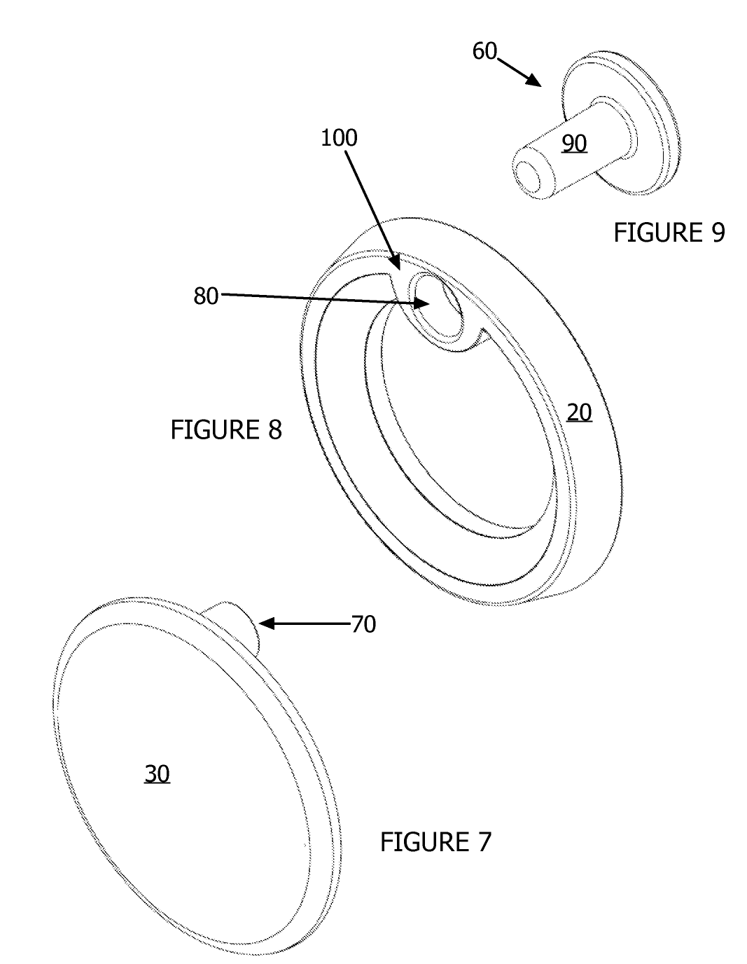

Referring to FIGS. 6-9, in one implementation, the outer cover 30 is rotatably coupled to the inner ring 20 via a pin 60. Outer cover 30 is fashioned such that a hollow cylindrical portion 70 may be inserted into a hole 80 of inner ring 20. Hollow cylindrical portion 70 is meant to be inserted through hole 80 via a front side 100 of inner ring 20. With hollow cylindrical portion 70 inserted into hole 80, pin 60 is inserted though hole 80 via the back side 45 of inner ring 20. Hollow cylindrical portion 70 is hollow which allows a shaft 90 of pin 60 to be inserted into hollow cylindrical portion 70.

Example materials that may be used to fabricate the inner ring 20, outer cover 30 and pin 60 are plastics and metals. A typical diameter, a distance between points 110 and 120 of FIG. 6, of a base of the inner ring 20 is about 1.75 inches.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A device for selectively blocking a view through a door viewer comprising:
a ring mountable over a door viewer wherein the ring encircles the door viewer; and
a cover rotatably coupled to the ring.

2. The device as recited in claim 1 further comprising a pin inserted through a back edge of the ring and utilized for rotatably coupling the cover to the ring.

3. The device as recited in claim 2 wherein the cover further comprises a hollow cylindrical portion insertable through a front edge of the ring wherein a shaft of the pin inserts into the hollow cylindrical portion.
